(19) United States
(12) Patent Application Publication
(10) Pub. No.: US 2022/0082239 A1
(43) Pub. Date: Mar. 17, 2022

(54) Multi-Sensor Flashlight

(71) Applicants: Taiwanna Y. Love, Milwaukee, WI (US); Antione D. Drew, JR., Fox Lake, WI (US); Vanesha S. Drew, Milwaukee, WI (US)

(72) Inventors: Taiwanna Y. Love, Milwaukee, WI (US); Antione D. Drew, JR., Fox Lake, WI (US); Vanesha S. Drew, Milwaukee, WI (US)

(21) Appl. No.: 17/476,823

(22) Filed: Sep. 16, 2021

Related U.S. Application Data
(60) Provisional application No. 63/079,081, filed on Sep. 16, 2020.

(51) Int. Cl. F21V 23/04; F21V 33/00; F21L 4/08; F21V 23/06

(52) U.S. Cl. CPC F21V 23/0414; F21V 23/06; F21L 4/085; F21V 33/0056

(57) ABSTRACT

A multi-sensor flashlight for law enforcement is provided. The multi-sensor flashlight includes a housing. The housing includes a working end, and a base. The working end includes a plurality of sensors and a lighting element. Among the plurality of sensors are a body count sensor, a pulse rate sensor, and a heart rate sensor. A control panel is disposed on the housing. The control panel includes a screen, a power actuator, and a plurality of toggle actuators. A user may select the desired sensor or the lighting element via the control panel. The plurality of sensors, the lighting element, and control panel are operably connected to a battery power supply. A plurality of charging ports, disposed on the base, provides power to the battery power supply. An onboard storage port, disposed on the base, permits the biometrics captured by the plurality of sensors to be recorded.

### CROSS REFERENCE TO RELATED APPLICATIONS

This application claims the benefit of U.S. Provisional Application No. 63/079,081 filed on Sep. 16, 2020. The above identified patent application is herein incorporated by reference in its entirety to provide continuity of disclosure.

### BACKGROUND OF THE INVENTION

The present invention relates to a flashlight. More specifically, the present invention provides a multi-sensor flashlight that includes a lighting element, a plurality of sensors, and an onboard storage port that allows for users to measure specific biometrics of an individual, or a group of individuals.

Law enforcement officers often respond to highly stressful situations. Typically, the law enforcement officers arrive at the scene and possess little information regarding the potential issue or threat that is occurring. Specifically, the law enforcement officers may lack knowledge of the amount of people that may be involved, or the biometrics of the people involved in the situation. Without knowing the amount of people involved or the tenor of the individuals involved, the law enforcement officers are at a disadvantage when they arrive. Additionally, the arrival of the law enforcement officers often escalates the emotions of all the parties involved. Such escalation in emotions will raise the tension in the specific situation and may lead to injury or death to the parties involved or the law enforcement officers that arrive. Preventing such disastrous results can allow the law enforcement officers to properly perform their duties with limited chances that an unnecessary result occurs.

Additionally, these distress calls that law enforcement officers regularly respond to may occur during the night. At such times, the law enforcement officers will be deprived of the necessary light to properly assess the situation that they are attempting to alleviate. Commonly, the law enforcement officers are provided flashlights both attached to their vehicle and on their persons. When having to operate a personal flashlight, they might only be able to visualize a some of the individuals that are at the scene. Since the personal flashlight only provides illumination to a finite area, the officers will be unaware of anything or anybody that may not fall within the illuminated area from the personal flashlight. Absent the full assessment of the situation, law enforcement officers may be left vulnerable or even prevent the law enforcement officer from providing the necessary assistance to alleviate the situation.

Specifically, the flashlights commonly used by law enforcement officers do not provide the officers with the ability to identify an accurate number of individuals that are at the scene of the distress call. The inability to correctly identify the amount of people that are present inhibits the law enforcement officers from properly assessing the situation and providing an accurate dispatch report so that the necessary number of back-up law enforcement officers may be called and arrive at the scene. Additionally, the law enforcement officers lack the ability to monitor any real-time biometrics of the individuals involved in the situation. Without knowing the pulse rate or the heart rate of the individuals involved, the law enforcement officers are deprived of the necessary information to correctly approach the situation.

Each situation that the law enforcement officer arrives at during a distress call contains individuals who are acting in different ways. In certain situations, knowledge of such biometrics will allow the law enforcement officers to take a proper approach to the individuals in order to prevent an unnecessary escalation of the situation. Any escalation of a situation involving a law enforcement officer and one or more individuals, that may have the propensity to commit violence or harm to themselves or others, may have devastating results to one or more parties. A complete understanding of the situation and the individuals involved will limit the chances that a situation escalates to a point where any party is harmed, injured, or killed unnecessarily.

Therefore, there is a defined need amongst the known art for a multi-sensor flashlight that includes a lighting element and a plurality of sensors that provide law enforcement officers with biometric readings of all individuals involved in a situation. The biometric readings will then provide the proper assistance to alleviate the situation and to prevent an unnecessary escalation.

### SUMMARY OF THE INVENTION

In view of the foregoing disadvantages inherent in the known types of flashlights now present in the known art, the present invention provides a multi-sensor flashlight wherein a plurality of sensors provides the user with biometric measurements of the desired population. The new multi-sensor flashlight also includes a control panel that allows the user to distinguish the biometric measurements that are performed by the plurality of sensors. Furthermore, the device provides the ability to store the measured biometric information on a removable memory card.

The present device includes a plurality of sensors. The plurality of sensors provides the user with biometric readings of the individual or group of individuals that the sensors are directed towards. A first sensor that is incorporated into the present invention is a body count sensor. The body count sensor will detect the number of individuals that are within the area that the sensor is aiming. The present invention will inform the user of the number of individuals that are measured by the body count sensor. With that, the user may identify all the individuals regardless of the user's physical ability to view all the individuals. This is especially useful to the user when they are using the present invention in a poorly lit area. A second sensor that is incorporated into the present invention is a pulse rate sensor. The pulse rate sensor will determine the pulse of the individual the sensor is directed towards. Knowing the pulse of the individual will assist the user in understanding the stress level of the individual. Moreover, knowledge of the individual's pulse will allow the user to properly assess the individual so to provide them the assistance needed to alleviate their stress and prevent the individual from becoming further stressed in the situation. A third sensor that is incorporated into the present invention is a heart rate sensor. The heart rate sensor will detect the heart rate of the individual that the user directs the sensor towards. Like the pulse rate sensor, the heart rate sensor will provide the user with the knowledge of the individual to properly assess the situation and prevent a further escalation that may have devastating results for any party involved.

Another aspect of the present device is the control panel. The control panel provides the user with the ability to select the feature that the present device utilizes. The user may select the specific sensor to use for the situation that they find themselves. If the user only wants to select a single sensor, then the control panel permits them to do so with ease. The ability to distinguish the sensor that the user wants to operate will allow them to just gather the biometric information that will assist them in that certain situation and not become overwhelmed with an abundance of biometric information. Additionally, the control panel allows the user to activate the lighting element of the present device. This will allow the user to selectively illuminate an area that lacks the proper lighting needed for them to act efficiently.

Yet another aspect of the present device is the onboard storage port. The onboard storage port allows a user to insert a removable memory card therein. The use of a removable memory card will allow for all information, specifically the measured biometrics, to be saved and transported to a centralized information bank. This will allow for the users to accurately show the biometrics that were read and subsequently displayed by the present invention that led them to act a certain way or user a specific method during a situation. The ability to save the information recorded by the present invention will limit any discrepancies that might be made following an interaction between the user and one or more individuals. Moreover, the saved information will provide insight in any interactions that occurs by the user to assure proper actions are made if an undesired result occurs following the use of the present invention.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the multi-sensor flashlight.

FIG. 2 shows a front view of an embodiment of the multi-sensor flashlight.

FIG. 3 shows a rear view of an embodiment of the multi-sensor flashlight.

FIG. 4 shows a close-up view of an embodiment of the multi-sensor flashlight.

### DETAILED DESCRIPTION OF THE INVENTION

Reference is made herein to the attached drawings. Like reference numerals are used throughout the drawings to depict like or similar elements of the multi-sensor flashlight. The figures are intended for representative purposes only and should not be limiting in any respect.

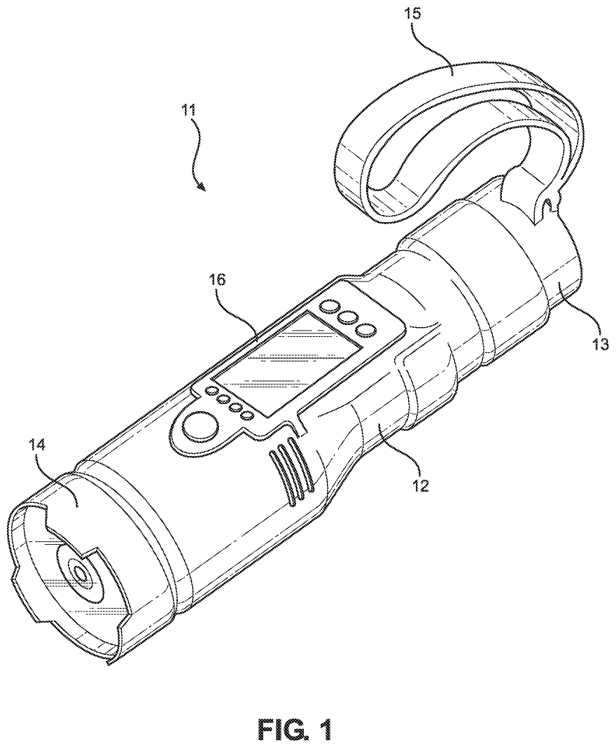

FIG. 1 shows a perspective view of an embodiment of a multi-sensor flashlight. The multi-sensor flashlight 11 includes a housing 12. The housing 12 further comprises a working end 14 and a base 13. The working end 14 and the base 13 are on opposing ends of the housing 12. In one embodiment, the housing 12 is a cylindrical body. The housing 12 being a cylindrical body allows the multi-sensor flashlight 11 to be comfortably held in the user's hand. A strap 15 is secured to the multi-sensor flashlight 11 via an aperture. The aperture is disposed on the base 13 of the multi-sensor flashlight 11. The strap 15 may encircle a user's wrist to prevent the multi-sensor flashlight 11 from falling out of their hand during use and resulting in the multi-sensor flashlight 11 to be damaged or broken. The strap 15 is adjustable to fit around the user's wrist and flexible to permit the user to maneuver their wrist as desired.

A control panel is centrally disposed on the housing 12. The control panel includes a screen 16. The screen 16 permits the user to operate the multi-sensor flashlight 11 as they desire. Specifically, the screen 16 allows the user to selectively operate a plurality of sensors and a lighting element located at the working end 14 of the multi-sensor flashlight 11. In use, the working end 14 will be directed towards the desired population. In that way, the plurality of sensors and the lighting element will be able to measure the specific biometrics that the user desires.

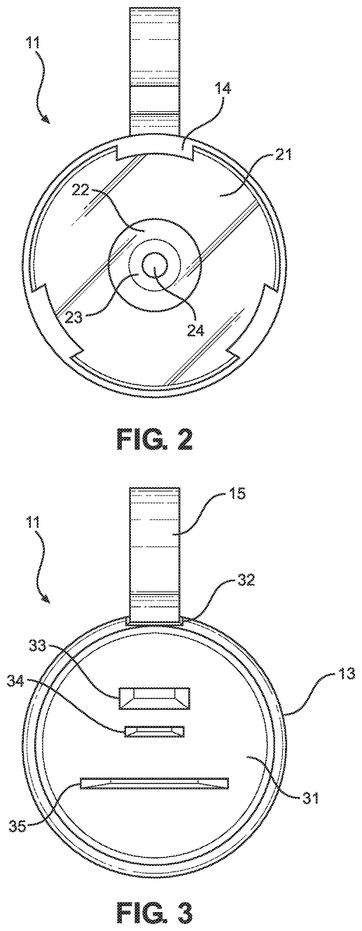

FIG. 2 shows a front view of an embodiment of a multi-sensor flashlight. The working end 14 of the multi-sensor flashlight 11 includes the plurality of sensors and the lighting element 21. The lighting element 21 is adjacently disposed to the plurality of sensors. In the shown embodiment, the plurality of sensors is concentric to the lighting element 21. The lighting element 21 provides directed illumination to a desired area. The lighting element 21 is operably connected to the control panel. The control panel allows a user to selectively activate or deactivate the lighting element 21 of the multi-sensor flashlight 11.

The plurality of sensors provides the user with the ability to perform biometric readings at the directed individual or group of individuals. A first sensor that is incorporated into the multi-sensor flashlight 11 is a body count sensor 22. The body count sensor 22 will determine the number of individuals that are within the desired area that the sensor is aimed towards. The use of the body count sensor 22 will make the user aware of all the individuals regardless of the user's physical ability to view all the individuals. Moreover, using the body count sensor 22 will assist the user when the lighting element 21 does not provide them with the appropriate amount of illumination in a poorly lit area. Typically, illumination from the lighting element 21 will not make the user aware of all individuals in the area at one time. Thus, the body count sensor 22 will provide the user with an accurate indication of the individuals that are present. The body count sensor 22 will be able to detect up to 2,500 individuals at one time. The body count sensor 22 will emit an infrared light towards the desired individual. The infrared light will detect the thermal energy that the individuals body emits and detects the number of distinct heat signatures that match a threshold of humanoid shapes. The body count sensor 22 is operably connected to the control panel. The control panel allows a user to selectively activate or deactivate the body count sensor 22.

A second sensor that is incorporated into the multi-sensor flashlight 11 is a pulse rate sensor 23. The pulse rate sensor 23 will be directed towards the desired individual to determine their pulse rate. The pulse rate allows the user to understand the stress of the individual or even indicate if the individual is alive. For users, knowing the pulse rate of the individual will allow for a proper assessment of the situation. In that, the proper assistance may be provided to alleviate the individual's stress and prevent the situation from resulting in harm, injury, or death to any party involved. The pulse rate sensor 23 is operably connected to the control panel. The control panel allows a user to selectively activate or deactivate the pulse rate sensor 23. The pulse rate sensor 23 provides a pulse oximetry reading. The pulse rate sensor 23 will emit a plurality of beams of light. The plurality of beams of light will pass through the individual's blood and measure the amount of oxygen present in the blood. The pulse rate sensor 23 will display the measured changes of light absorption in oxygenated or deoxygenated blood.

A third sensor that is incorporated into the multi-sensor flashlight 11 is a heart rate sensor 24. The heart rate sensor 24 will determine the heart rate of the individual that the user directs the multi-sensor flashlight 11 towards. The heart rate sensor 24 will allow the user to know the status of the individual or group of individuals to properly assess the situation and prevent a further escalation. The heart rate sensor 24 is operably connected to the control panel. The control panel allows a user to selectively activate or deactivate the heart rate sensor 24. The heart rate sensor 24 provides the individual's heart beats per minute. In one embodiment of the heart rate sensor 24, the heart rate sensor 24 will emit a beam of light. The beam of light will pass through the individual's skin and measure the amount of light that reflects back. The light that is reflected back to the multi-sensor flashlight 11 will vary depending on the pulsations of the individual's blood under their skin. The heart rate sensor 24 will display the variations in the reflections of light and be displayed as heart beats per minute on the display.

FIG. 3 shows a rear view of an embodiment of a multi-sensor flashlight. The multi-sensor flashlight 11 includes the base 13 on the opposing end of the working end. The base 13 includes a flat surface 31. A plurality of charging ports and an onboard storage port 35 are disposed on the flat surface 31. A first charging port includes a micro Universal Serial Bus (“USB”) port 33. The micro USB port 33 is operably connected to a battery power supply. The micro USB port 35 is configured to receive a micro USB cord that is connected to a power source. The power source will supply power to the battery power supply via the micro USB port 33. A second charging port includes a mini USB port 34. The mini USB port 34 is operably connected to the battery power supply. The mini USB port 34 is configured to receive a mini USB cord that is connected to a power source. The power source will supply power to the battery power supply via the mini USB port 34. The power received by the plurality of charging ports will be stored in an internal battery. The internal battery will be encased in the housing of the multi-sensor flashlight 11.

The onboard storage port 35 is configured to receive a removable memory card therein. In one embodiment, the onboard storage port 35 includes a Secure Digital (“SD”) card reader and the removable memory card is an SD card. In use, the removable memory card will be inserted into the onboard storage port 35. The biometrics measured by the plurality of sensors will be saved on the removable memory card. Then the user will remove the removable memory card from the onboard storage port 35. After the removable memory card is removed from the multi-sensor flashlight 11, the user may transport the biometrics to a centralized data system.

An aperture 32 is disposed on an edge of the flat surface 31. The aperture 32 extends inwardly and upwardly from the base 13. The aperture 32 extends towards the housing, defining a channel. The strap 15 is secured to the multi-sensor flashlight 11 via the aperture 32. This permits the user to secure the strap 15 to their wrist while the multi-sensor flashlight 11 is being used. This will prevent the user from dropping the multi-sensor flashlight 11, resulting in the multi-sensor flashlight 11 becoming damaged or otherwise broken. The strap 15 is flexible and adjustable to conform to the user's wrist. The strap 15 will not restrict the user's ability to move while they are utilizing the multi-sensor flashlight 11.

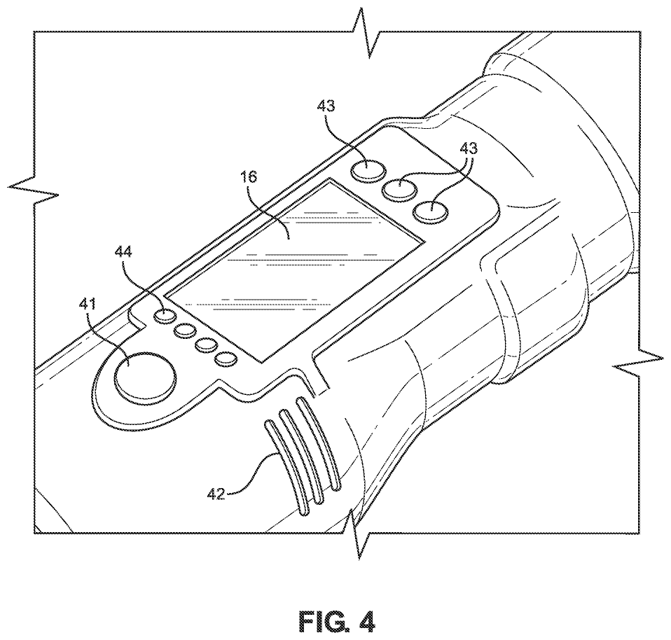

FIG. 4 shows a close-up view of an embodiment of a multi-sensor flashlight. The multi-sensor flashlight includes a control panel. The control panel comprises the screen 16, a power actuator 41, a plurality of toggle buttons 43, a speaker 42, and a plurality of power indicating lights 44. The speaker 42 is disposed on the housing. In one embodiment, the power actuator 41 is a push button. In one embodiment, the plurality of toggle actuators 43 is push buttons.

When the user engages the power actuator 41, the multi-sensor flashlight will power on. When the user disengages the power actuator 41, the multi-sensor flashlight will power off. When the multi-sensor flashlight is powered on, power will be supplied to the screen 16. The screen 16 is affixed to the housing. In one embodiment, the screen 16 comprises an LED display. The screen 16 will display a menu whereby the user may selectively activate the plurality of sensors or the lighting element. The user may select the specific sensors or the lighting element using the plurality of toggle buttons 43. Moreover, the screen 16 will display the biometrics that are detected when the plurality of sensors is activated. The data will then be saved to the removable memory card that is inserted into the onboard storage port. In one embodiment, one of the toggle buttons 43 will include a validation key. The validation key will allow the user to select an option on the screen 16.

The plurality of power indicating lights 44 will indicate the sensor or the lighting element that the user has selected to activate on the multi-sensor flashlight. In one embodiment, the plurality of power indicating lights 44 is configured to appear in an assortment of colors. In the same embodiment, a first power indicating light will illuminate a red light. The red light will illuminate when the user activates the heart rate sensor. The red light will continuously flash when the multi-sensor flashlight requires a charge. In the same embodiment, a second power indicating light will illuminate a green light. The green light will illuminate when the user activates the body count sensor. The green light will flash when the multi-sensor flashlight is powered off but has a full charge. In the same embodiment, a third power indicating light will illuminate a blue light. The blue light will illuminate when the user activates the pulse rate sensor. In the same embodiment, a fourth power indicating light will illuminate a white light. The white light will illuminate when the user activates the lighting element.

The speaker 42 is operably connected to the control panel. The speaker 42 will emit a sound. The sound may be used to get the attention from individuals that are proximate to the user when the multi-sensor flashlight is in use. The user may activate the speaker 42 from the menu on the screen 16. Moreover, the screen 16 further comprises a digital clock. The digital clock will assist the user in identifying the time and record the time that the user activates the multi-sensor flashlight, the plurality of sensors, or the lighting element. In one embodiment, the multi-sensor flashlight includes an integrated Global Positioning System (“GPS”). The integrated GPS will allow for the multi-sensor flashlight to be tracked and detected in case of an emergency and the user loses radio signal and needs to be found.

It is therefore submitted that the instant invention has been shown and described in what is the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention

We claim:

1. A multi-sensor flashlight, comprising:
a housing;
wherein the housing comprises a working end, and a base;
wherein the working end and the base are on opposing ends of the housing;
a control panel is centrally disposed on the housing;
wherein the control panel includes a screen, a power actuator, and a plurality of toggle actuators;
a speaker is disposed on the housing;
wherein the speaker is operably connected to the control panel;
the working end comprises a plurality of sensors and a lighting element;
wherein the plurality of sensors and the lighting element are operably connected to the control panel;
the base comprises a plurality of charging ports and an onboard storage port;
the base further comprises an aperture; and
wherein a strap secured to the aperture.

2. The multi-sensor flashlight of claim 1, wherein the housing is a cylindrical body.

3. The multi-sensor flashlight of claim 1, wherein the lighting element is centrally disposed on the working end, coaxially aligned with the longitudinal axis of the housing; whereby the plurality of sensors is concentric orientated about the lighting element on the working end.

4. The multi-sensor flashlight of claim 1, wherein the plurality of sensors includes a body count sensor, a pulse rate sensor, and a heart rate sensor.

5. The multi-sensor flashlight of claim 1, wherein the plurality of charging ports includes a micro-USB port and a mini-USB port.

6. The multi-sensor flashlight of claim 1, wherein the plurality of charging ports is operably connected to a battery power supply that supplies power to the control panel.

7. The multi-sensor flashlight of claim 1, wherein the control panel further comprises a plurality of power indicating lights.

8. The multi-sensor flashlight of claim 7, wherein the plurality of power indicating lights is capable of multi-color illumination and flashing.

9. The multi-sensor flashlight of claim 7, whereby each light of the plurality of indicating lights comprises a distinct color to indicate certain operating conditions.

10. The multi-sensor flashlight of claim 1, wherein the onboard storage port includes an SD card reader.

11. The multi-sensor flashlight of claim 1, wherein the screen comprises an LED display.

12. The multi-sensor flashlight of claim 1, wherein the screen further comprises a digital clock

13. The multi-sensor flashlight of claim 1, wherein the aperture is disposed on an edge of the base.

14. The multi-sensor flashlight of claim 1, wherein the power actuator is a push button.

15. The multi-sensor flashlight of claim 1, wherein the plurality of toggle actuators is push buttons.

16. The multi-sensor flashlight of claim 1, wherein the control panel is operably connected to an integrated GPS.
